(19) United States
(12) Patent Application Publication
(10) Pub. No.: US 2023/0174703 A1
(43) Pub. Date: Jun. 8, 2023

(54) A BINDER COMPOSITION

(71) Applicant: Huntsman International LLC, The Woodlands, TX (US)

(72) Inventors: Yanxia XU, Shanghai (CN); Tao LIN, Shanghai (CN); Wei DAI, Shanghai (CN)

(21) Appl. No.: 17/998,435

(22) PCT Filed: May 11, 2020
(86) PCT No.: PCT/CN2020/089630

§ 371 Date: Nov. 10, 2022

(51) Int. Cl. C08G 18/10; C09J 175/04; C08G 18/38

(52) U.S. Cl. CPC C08G 18/10; C09J 175/04; C08G 18/3885

(57) ABSTRACT

The present disclosure generally provides binder compositions and more specially polyfunctional isocyanate binder compositions which can be used in the preparation of composite wood panels, wherein the binder composition comprising (a) a polyfunctional isocyanate or an isocyanate prepolymer, wherein the isocyanate prepolymer is obtained by reacting a polyfunctional isocyanate with a polyfunctional polyol; (b) a tackifier; and (c) a phosphate ester. The compositions have high tack capability and improved mold releasing capability.

### FIELD OF THE INVENTION

The present disclosure relates generally to binder compositions and more specially to polyfunctional isocyanate binder compositions which can be used in the preparation of composite wood panels.

### BACKGROUND INFORMATION

The use of isocyanate, tackifier and release agent mixture to form lignocellulosic composite is already known in the art.

WO2009061474 discloses an isocyanate, tackifier and release agent blend binder. But the type and the amount of release agent used in this patent application are different from the current disclosure.

WO20150484441 discloses a diisocyanate, tackifier and phosphate blend binder. But the amount of the phosphate and the type of the tackifier used in this patent application are different from the current disclosure.

However, known solutions are not able to provide a binder composition with high tack capability and improved mold releasing capability, which can be suitable for use in the composite wood panels.

### SUMMARY OF THE INVENTION

It has now been surprisingly found that the compositions and processes of the present disclosure address the above problem. Advantages of the present disclosure may include: (1) high tack capability; (2) improved mold releasing capability; and (3) environmental friendly.

The present disclosure is concerned with binder compositions and processes for preparing these compositions. In one embodiment, the disclosure provides a binder composition comprising:

(a) a polyfunctional isocyanate or an isocyanate prepolymer, wherein the isocyanate prepolymer is obtained by reacting a polyfunctional isocyanate with a polyfunctional polyol;

(b) a tackifier; and (c) a phosphate ester.

In another embodiment, the present disclosure provides a process for making the binder compositions.

In still another embodiment, the present disclosure provides a method of using the binder compositions in the preparation of composite wood panels, preferably, particle boards and plywood.

### BRIEF DESCRIPTION OF THE FIGURES

FIG. 1 is a graph depicting the effect on time on tack level for formulations of Example 1 to 8.

FIG. 2A shows the trial of particle board in a precompression step using the composition of Example 9 wherein the release agent of the present disclosure is used; FIG. 2B shows the trial of particle board in a precompression step using the composition of Example 10 wherein a release agent not from the present disclosure is used; FIG. 2C shows the trial of particle board in a precompression step using the composition of Example 11 wherein no release agent is used;

### DETAILED DESCRIPTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination. The articles “a” and “an” are used herein to refer to one or to more than one (i.e. to at least one) of the grammatical object of the article. By way of example, “a resin” means one resin or more than one resin.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The present disclosure generally provides a binder composition comprising: (a) a polyfunctional isocyanate or an isocyanate prepolymer, wherein the isocyanate prepolymer is obtained by reacting a polyfunctional isocyanate with a polyfunctional polyol; (b) a tackifier; and (c) a phosphate ester.

According to one embodiment, the polyfunctional isocyanate includes those represented by the formula Q(NCO)ₙ where n is a number from 2-5, preferably 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms, wherein aromatic hydrocarbon groups are in general preferred.

Examples of polyfunctional isocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (polymeric MDI); norbornane diisocyanates; m- and p-isocyanatophenyl sulfonylisocyanates; perchlorinated aryl polyisocyanates; modified polyfunctional isocyanates containing carbodiimide groups, urethane groups, allophonate groups, isocyanurate groups, urea groups, or biruret groups; polyfunctional isocyanates obtained by telomerization reactions; polyfunctional isocyanates containing ester groups; and polyfunctional isocyanates containing polymeric fatty acid groups. Those skilled in the art will recognize that it is also possible to use mixtures of the polyfunctional isocyanates described above, preferably using mixture of polymeric MDI, mixture of MDI isomers and mixture of TDI.

In another embodiment, prepolymers of MDI or TDI can also be used as an alternative of MDI or TDI. Prepolymers of MDI or TDI are prepared by the reaction of an excess of above mentioned polyfunctional isocyanates (such as an MDI or TDI) and a polyfunctional polyol. The prepolymer preferably has an NCO value of 20-35% by weight. The synthesis processes of prepolymers of MDI or TDI are known in the art (see for example Polyurethanes Handbook 2^{nd} edition, G. Oertel, 1994).

The polyfunctional polyols for use in the present disclosure may include, but are not limited to, polyether polyols, polyester polyols, biorenewable polyols, polymer polyols, a non-flammable polyol such as a phosphorus-containing polyol or a halogen-containing polyol. Such polyols may be used alone or in suitable combination as a mixture.

General functionality of polyfunctional polyols used in the present invention is between 2 to 6. Polyether polyols for use in the present disclosure include alkylene oxide polyether polyols such as ethylene oxide polyether polyols and propylene oxide polyether polyols and copolymers of ethylene and propylene oxide with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols for use in the present invention include, but are not limited to, those produced by reacting a dicarboxylic acid with an excess of a diol, for example, adipic acid with ethylene glycol or butanediol, or reaction of a lactone with an excess of a diol such as caprolactone with propylene glycol. In addition, polyester polyols for use in the present invention may also include: linear or lightly branched aliphatic (mainly adipates) polyols with terminal hydroxyl group; low molecular weight aromatic polyesters; polycaprolactones; polycarbonate polyol. Those linear or lightly branched aliphatic(mainly adipates) polyols with terminal hydroxyl group are produced by reacting a dicarboxyl acids with an excess of diols, triols and their mixture; those dicarboxyl acids include, but are not limited to, for example, adipic acid, AGS mixed acid; those diols, triols include, but are not limited to, for example, ethylene glycol, diethylene glycol, propylene glycol, dipropylene glycol, 1,4-butane diol, 1,6-hexane diol, glycerol, trimethylolpropane and pentaerythritol. Those low molecular weight aromatic polyesters include products derived from the process residues of dimethyl terephalate (DMT) production, commonly referred to as DMT still bottoms, products derived from the glycolysis of recycled poly(ethyleneterephthalate) (PET) bottles or magnetic tape with subsequent re-esterification with di-acids or reaction with alkylene oxides, and products derived by the directed esterification of phthalic anhydride. Polycaprolactones are produced by the ring opening of caprolactones in the presence of an initiator and catalyst. The initiator includes ethylene glycol, diethylene glycol, propylene glycol, dipropylene glycol, 1,4-butane diol, 1,6-hexane diol, glycerol, trimethylolpropane and pentaerythritol. Polycarbonate polyols are derived from carbonic acid—that can be produced through the polycondensation of diols with phosgene, although transesterification of diols, commonly hexane diol, with a carbonic acid ester, such as diphenylcarbonate.

Biorenewable polyols suitable for use in the present invention include castor oil, sunflower oil, palm kernel oil, palm oil, canola oil, rapeseed oil, soybean oil, corn oil, peanut oil, olive oil, algae oil, and mixtures thereof.

Examples of polyfunctional polyols also include, but are not limited to, graft polyols or polyurea modified polyols. Graft polyols comprise a triol in which vinyl monomers are graft copolymerized. Suitable vinyl monomers include, for example, styrene, or acrylonitrile. A polyurea modified polyol, is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol.

The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrine or trichlorobutylene oxide.

In a preferred embodiment, the polyfunctional polyol is polyether polyol.

The tackifier suitable for use in the present disclosure may include a homopolymer of vinyl acetate or a copolymer of vinyl acetate or a mixture thereof.

In a preferred embodiment, the tackifier is a copolymer of vinyl acetate, and more preferred a vinyl acetate ethylene copolymer.

The molecular weight of tackifiers may be in an amount ranging from 10000 to about 2000000, preferably from 100000 to about 1000000.

Molecular weight (MW) is weight average molecular weight which is defined by Gel Permeation Chromatography (GPC) method with polystyrene as a reference.

The proportion of said tackifiers is generally in an amount ranging from 0.5% to 80% by weight, preferably from 5% to 50% based on the binder composition.

A mold release agent is a chemical used to prevent other materials from bonding to surfaces. It provides the critical barrier between a molding surface and the substrate, facilitating separation of the cured part from the mold. Without such a barrier in place, the substrate would become fused to the mold surface, resulting in difficult clean-up and dramatic loss in production efficiency. Even when a mold release agent is used, improper mold release agent choice may have a dramatic effect on the quality and consistency of the finished product.

It is found that adding phosphate ester in the binder composition of the present disclosure can improve mold releasing capability.

In a preferred embodiment, the phosphate ester is an alkylether phosphate or a mixture of alkyl phosphate and alkylether phosphate.

The molecular weight of phosphate ester may be in an amount ranging from about 200 to about 2000, preferably from about 300 to about 1000.

The weight ratio of the tackifier to the phosphate ester is in the range from about 30:1 to about 20000:1, preferably from about 500:1 to about 2000:1.

In the present disclosure, the composition further includes wax.

In one embodiment, the proportion of the wax present in the binder composition is in an amount ranging from 1.5% to 50% by weight, preferably from 15% to 30% based on the total weight of the binder composition.

In another embodiment, the binder composition may further optionally comprise fire retardants, antioxidants, solvents, surfactants, crosslinking agent, fillers, pigments, or any other typical additives used in isocyanate materials.

Advantages of the disclosed composition may include: (1) high tack capability; (2) improved mold releasing capability; and (3) environmental-friendly.

The present disclosure also provides a process for making the binder composition, comprising mixing the tackifier and the phosphate ester in a first step and then adding the polyfunctional isocyanate or the isocyanate prepolymer in a second step.

Furthermore, the present disclosure also provides the method of using the binder compositions in the preparation of composite wood panels, preferably, particle boards and plywood. The examples which now follow should be considered exemplary of the present disclosure, and not delimitive thereof in any way.

Raw Materials

Polyfunctional Isocyanate: SUPRASEC® 5005 polymeric MDI (Supplier: Huntsman Corporation, USA);

Isocyanate Prepolymer: I-BOND® PB EFC 4322 MDI prepolymer (Supplier: Huntsman Corporation, USA);

Tackifier A: EAF 7012 copolymer of vinyl acetate (Supplier: Wacker Chemicals, Nanjing, China);

Tackifier B: 1502 polymerized styrene butadiene rubber (Supplier: Sinopec Qilu Petrochemical, China);

Tackifier C: PU-608 polyurethane dispersions (Supplier: Guangzhou Guanzhi New Material Technology, China);

UF: UFC80 urea-formaldehyde resin (Supplier: Dynea Guangdong, China);

Mold Release A: Tech Lube HB-550D alkylether phosphate (Supplier: Technick Products, USA);

Mold Release B: 1310P trideceth-10 phosphate (Supplier: Nantong Chenrun Chemical, China);

Mold Release C: FR-1000A fluorinated silicone (Supplier: Neos Shanghai, China);

Wax: FR54 fully refined paraffin wax (Supplier: PetroChina Chemical Industry Company Limited, China)

### Examples 1-8

The components of binder composition for Examples 1 through 8 are shown in Table 1. All values listed in Table 1 refer to parts by weight of the component. As shown in Table 1, Example 7 was blank example that contained no tackifier or phosphate ester. Example 8 was comparative example that contained UF as binder.

TABLE 1

| Binder | | | | | | | | |
|---|---|---|---|---|---|---|---|---|
| Composition | Example | | | | | | | |
| Formulation | 1 | 2 | 3 | 4 | 5 | 6 | 7 | 8 |
| Mold Release A | 0.02 | 0.04 | | 0.03 | 0.03 | 0.03 | | |
| Tackifier A | 18 | 18 | 18 | 30 | | | | |
| Tackifier B | | | | | 30 | | | |
| Tackifier C | | | | | | 30 | | |
| water | 1.98 | 1.96 | 2 | 3.3 | 3.3 | 3.3 | | |
| Polyfunctional | 80 | 80 | 80 | 66.67 | 66.67 | 66.67 | 100 | |
| Isocyanate A | | | | | | | | |
| UF | | | | | | | | 100 |

Procedure

For each example 1-8, wood particles (B) were blended in a small food processor machine for approximately 60 seconds while each component of the binder composition (A) was drip added to the wood particles one by another while mixing in the proportion (by weight) of A:B=1:20 and water was added to the blended material to control the moisture content of the blended material to 30%. After mixing the blended material was removed from the food processor and placed in the experimenter's hand (holding hand). In a next step, a ball was attempted to be made in the hand by compressing the material for three seconds. The compressing was accomplished by squeezing the ball with the holding hand. The ball was then given a tack rating based on the formed ball integrity. The rating system is shown in Table 2 below. After tack assessment, a new ball was made and then placed in a neat pile on the laboratory bench top and again tested for tack every 5 minutes, until 40 minutes from the blending time had passed. The tack assessment was performed according to a method known in the art (see for example patent application WO2013096148A).

TABLE 2

| Tack Rating* | Description |
|---|---|
| 1 | No tack |
| 2 | ≥¼ edge broken and ≥½ crack |
| 3 | ≥⅛ and ≤¼ edge broken and ≤½ crack |
| 4 | Tack (≤⅛ cycle edge broken) |
| 5 | High tack |

*½ ratings are used in cases where the results fall between two ratings on the Tack Rating scale.

### Examples 9-11

The components of binder composition for Examples 9 through 11 are shown in Table 3. All values listed in Table 3 refer to parts by weight of the component. As shown in Table 3, Examples 10 is comparative example that contained a release agent not from the present disclosure; Examples 11 is comparative example that contained no release agent.

TABLE 3

| | Example | | | | | |
|---|---|---|---|---|---|---|
| Binder | 9 | | 10 | | 11 | |
| Composition | Surface | Core | Surface | Core | Surface | Core |
| Formulation | layer | layer | layer | layer | layer | layer |
| Mold Release B | 0.06 | 0.01 | | | | |
| Mold Release C | | | 0.06 | 0.01 | | |
| Tackifier A | 51.43 | 8.18 | 51.43 | 8.18 | 51.43 | 8.18 |
| water | 5.66 | 0.9 | 5.66 | 0.9 | 5.72 | 0.91 |
| Polyfunctional | 28.57 | | 28.57 | | 28.57 | |
| Isocyanate | | | | | | |
| Isocyanate | | 63.64 | | 63.64 | | 63.64 |
| Prepolymer | | | | | | |
| Wax | 14.28 | 27.27 | 14.28 | 27.27 | 14.28 | 27.27 |

Procedure

Particleboard furnish for surface layer (A) and core layer (B) was placed in separate stainless steel bunker. The stainless bunker was transferred to the blender and each component of the binder composition (C) of Example 8 to 10 was added one by another in a continuous sprayer addition in the proportion (by weight) of A:C=100:14 and B:C=100:5.5 and water was added to the blended material to control the moisture content of the surface layer to 16% and core layer to 5%. The mixture of the surface layer and the core layer is initially formed into a loose formed mat, and the mat is then pressed between two rubber belts at room temperature and at under a pressure of 1 to 1.5 Mpa for 10 to 30 seconds to reduce the thickness of the mat (Precompression Step), the mat was then further pressed between two steel belts at an elevated temperature between 180 to 220° C. and under a pressure between 2-4 Mpa for 3 to 6 minutes to form a particleboard.

The particleboard is prepared according to a process known in the art (see for example patent application WO9717388A).

The resultant samples were evaluated for its physical properties in accordance with GBT 17657-2013 method.

Results

Tack Performance

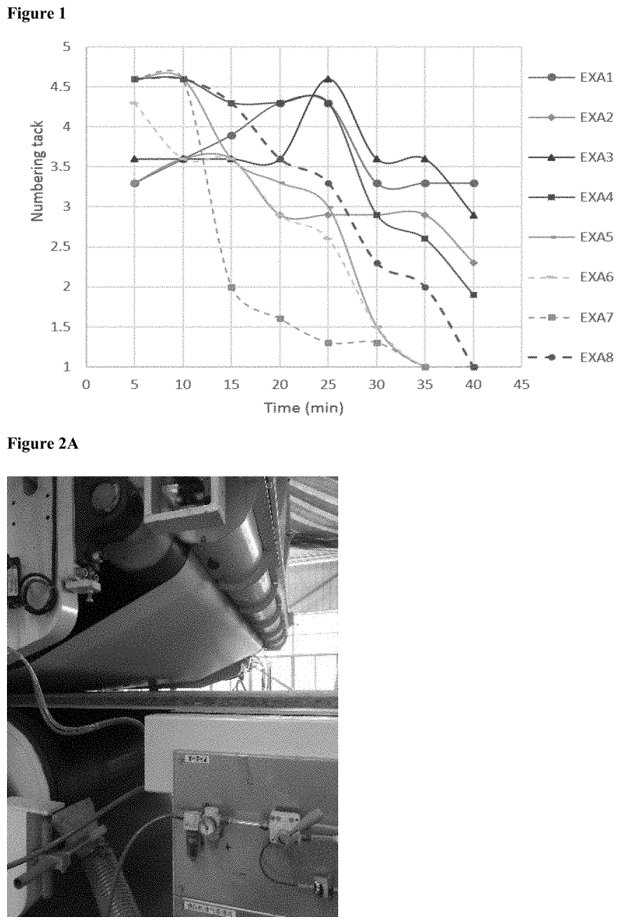

As shown in FIG. 1, different kinds of tackifiers can bring good tack performance compared to the blank Example (Example 7) which loses tack very fast. The composition using copolymer of vinyl acetate as tackifier has the better tack performance (Example 1 to 4). However, when the amount of phosphate ester is too high, there is impact on the tack performance (Example 2). UF is a binder widely used in the composite wood industry, which has good tack performance (Example 8). But UF has formaldehyde emission. The binder compositions of the present disclosure match or exceed the tack performance of UF.

Mold Release Performance

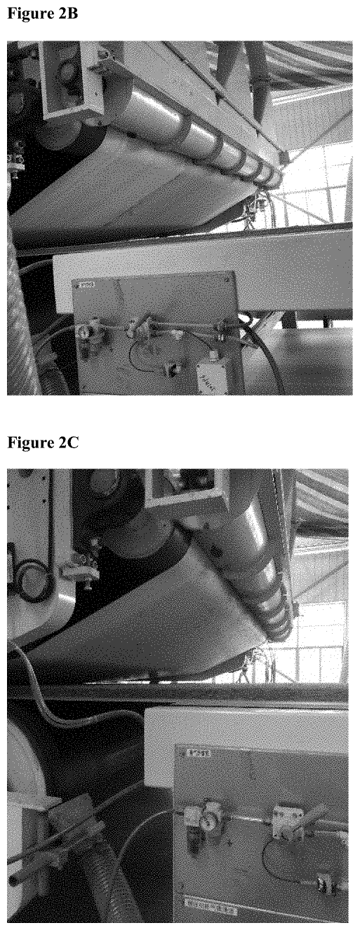

As shown in FIG. 2A, the mat of particle board in the precompression step using the composition of the present disclosure has good mold release performance (Example 9); As shown in FIG. 2B, the mat of particle board in the precompression step using a release agent not from the present disclosure stuck to the rubber belt (Examples 10); As shown in FIG. 2C, the mat of particle board in the precompression step which contained no release agent stuck to the rubber belt and the surface of the mat is destroyed (Example 11).

Physical Property

TABLE 4

| | | Modulus | Modulus | | 24 hours | | |
|---|---|---|---|---|---|---|---|
| | | of | of | Surface | Thickness | Formaldehyde | Moisture |
| | Density | Rupture | Elasticity | Strength | Swelling | Emission | Content |
| | [kg/m³] | [Mpa] | [Mpa] | [Mpa] | Rate [%] | [mg/100 g] | [%] |
| Example 9 | 612 | 14.5 | 2755 | 0.9 | 5.1 | 5.6 | 5.0 |
| Example 10 | 554 | 9.8 | 1985 | 0.3 | 10.7 | 6.1 | 4.3 |

| | |
|---|---|
| Example11 | Surface broken and can not form a particle board |

Table 4 shows the particle board using the composition of the present disclosure has good physical property (Example 9); However, the particle board using a different release agent or no release agent may either form a bad particle board (Examples 10) or fail to form a particle board (Examples 11).

1. A binder composition comprising:
(a) a polyfunctional isocyanate or an isocyanate prepolymer, wherein the isocyanate prepolymer is obtained by reacting a polyfunctional isocyanate with a polyfunctional polyol;
(b) a tackifier; and
(c) a phosphate ester.

2. The binder composition of claim 1 wherein the polyfunctional isocyanate is a polymeric MDI or an MDI isomer mixture or a mixture thereof.

3. The binder composition of claim 1 wherein the molecular weight of the tackifier is in an amount ranging from about 10000 to about 2000000.

4. The binder composition of claim 1 wherein the tackifier is a homopolymer of vinyl acetate or a copolymer of vinyl acetate or a mixture thereof.

5. The binder composition of claim 1 wherein the phosphate ester is an alkylether phosphate or a mixture of alkyl phosphate and alkylether phosphate.

6. The binder composition of claim 1 wherein the molecular weight of the phosphate ester is in an amount ranging from about 200 to about 2000, preferably from about 300 to about 1000.

7. The binder composition of claim 1 wherein the weight ratio of the tackifier to the phosphate ester is in the range from about 30:1 to about 20000:1.

8. The binder composition of claim 1 wherein the binder composition further comprises a wax.

9. A process for making the binder composition of claim 1, comprising mixing the tackifier and the phosphate ester in a first step and then adding the polyfunctional isocyanate or the isocyanate prepolymer in a second step.

10. A composite wood comprising the binder composition of claim 1.
